(19) United States
(12) Patent Application Publication
(10) Pub. No.: US 2021/0001453 A1
(43) Pub. Date: Jan. 7, 2021

(54) Concentric Abrasive Disc Punch

(71) Applicant: ARCOSA Wind Towers, Inc., Dallas, TX (US)

(72) Inventors: Bruce C. Janvrin, Ames, IA (US); Gregory L. Rhames, Colfax, IA (US)

(21) Appl. No.: 16/502,303

(22) Filed: Jul. 3, 2019

(51) Int. Cl. B24D 11/00; B24D 18/00

(52) U.S. Cl. CPC B24D 11/008; B26F 1/3846; B24D 18/0009

(57) ABSTRACT

According to some embodiments, an abrasive disc punch comprises: a bottom plate; a top plate parallel to the bottom plate and coupled to the bottom plate via guide pins; springs coupled between the bottom plate and the top plate; a punch coupled to the top plate; and a cutting block coupled to the bottom plate. The cutting block comprises a cutting edge that is aligned coaxially with the punch. The abrasive disc punch further comprises a trim cushion coupled to the cutting block via a spring. The trim cushion is positioned within the cutting edge of the cutting block and comprises a flat horizontal top portion. In an open position the two or more springs separate the top plate and punch from the bottom plate and the cutting block, and the flat horizontal top portion of the trim cushion is positioned above the cutting edge of the cutting block.

### TECHNICAL FIELD

Particular embodiments relate generally to a concentric abrasive disc punch for cutting abrasive discs.

### BACKGROUND

Abrasive discs, also referred to as sanding discs, may perform a variety of applications, such as sanding, finishing, grinding, surface preparation, deburring, etc. Particular examples include weld removal, polishing metal surfaces, smoothing composites such as gel coats and fiberglass, and removal of rust, paint, or other coatings.

The abrasive disc comprises an abrasive grain adhered to a backing material. The particular abrasive grain used may vary by application (e.g., type of surface, hardness of material, etc.), and may include abrasive grains such as aluminum oxide, garnet, tungsten carbide, ceramics and super abrasive grains such as diamond and cubic boron nitride. The backing material may include cloth, fiber, film, paper, foam, sponge, or other materials, and may also depend on the particular application.

Abrasive discs may be mounted on a sander, grinder, or similar tool for use in the variety of sanding, grinding, polishing, and surface preparation applications. Abrasive discs have applications in a variety of industries, including metalworking, woodworking, ceramics, and general industrial manufacturing. The size and shape of an abrasive disc may vary based on application.

### SUMMARY

According to some embodiments, an abrasive disc punch comprises: a bottom plate; a top plate parallel to the bottom plate and coupled to the bottom plate via two or more guide pins; two or more springs coupled between the bottom plate and the top plate; a punch coupled to the top plate; and a cutting block coupled to the bottom plate. The cutting block comprises a top portion with a cutting edge. The cutting edge is aligned coaxially with the punch. The abrasive disc punch further comprises a trim cushion coupled to the cutting block via at least one spring. The trim cushion is positioned within the cutting edge of the cutting block. The trim cushion comprises a flat horizontal top portion for supporting an abrasive disc. In an open position, the two or more springs separate the top plate and punch from the bottom plate and the cutting block, and the flat horizontal top portion of the trim cushion is positioned above the cutting edge of the cutting block.

In particular embodiments, a top portion of the cutting block slopes downward and away from the cutting edge towards the sides of the cutting block. The punch may include a magnet centered coaxially on the punch for aligning an abrasive disc.

In particular embodiments, the cutting block further comprises one more breathers that permit air flow into and out of voids between the cutting block and the trim cushion during a compression stroke of the abrasive disc punch. The abrasive disc punch may further comprise a regulated air source coupled to the one or more breathers.

In particular embodiments, the cutting edge forms a five inch diameter circle. The abrasive disc punch may comprise two guide pins positioned along a first edge of the top plate and the bottom plate and two guide pins positioned along a second edge opposite the first edge of the top plate and the bottom plate. The abrasive disc punch may comprise a liner guide coupled to the trim cushion and configured to restrict lateral movement of the trim cushion during a compression stroke of the abrasive disc punch. The two or more springs may comprise two or more gas pistons.

According to some embodiments a method for trimming an abrasive disc comprises positioning an abrasive disc punch on a work table of a press. The abrasive disc punch comprises: a bottom plate; a top plate parallel to the bottom plate and coupled to the bottom plate via two or more guide pins; two or more springs coupled between the bottom plate and the top plate; a punch coupled to the top plate; and a cutting block coupled to the bottom plate. The cutting block comprises a top portion with a cutting edge. The cutting edge is aligned coaxially with the punch. The abrasive disc punch further comprises a trim cushion coupled to the cutting block via at least one spring. The trim cushion is positioned within the cutting edge of the cutting block. The trim cushion comprises a flat horizontal top portion for supporting an abrasive disc. In an open position, the two or more springs separate the top plate and punch from the bottom plate and the cutting block, and the flat horizontal top portion of the trim cushion is positioned above the cutting edge of the cutting block. The method further comprises: inserting an abrasive disc into the abrasive disc punch; activating the press to compress the abrasive disc punch causing the punch to shear the abrasive disc against the cutting edge; deactivating the press to return the abrasive disc punch to the open position; and removing the trimmed abrasive disc from the abrasive disc punch.

### BRIEF DESCRIPTION OF THE DRAWINGS

For a more complete understanding of the particular embodiments, and the advantages thereof, reference is now made to the following written description taken in conjunction with the accompanying drawings, in which:

FIG. 1 is a schematic perspective drawing illustrating a concentric abrasive disc punch, according to a particular embodiment;

FIG. 2 is a schematic drawing illustrating a side view of a concentric abrasive disc punch, according to a particular embodiment;

FIG. 3 is a schematic drawing illustrating an end view of a concentric abrasive disc punch, according to a particular embodiment;

FIG. 4 is a schematic drawing illustrating an overhead view of a concentric abrasive disc punch, according to a particular embodiment;

FIG. 5 is a schematic drawing illustrating an underneath view of a concentric abrasive disc punch, according to a particular embodiment;

FIG. 6 is an exploded perspective schematic of the cutting block and trim cushion, according to a particular embodiment;

FIG. 7 is a schematic drawing illustrating a side view of the cutting block and trim cushion, according to a particular embodiment;

FIG. 8 is a schematic drawing illustrating a top view of the cutting block and trim cushion, according to a particular embodiment;

FIG. 9 is schematic drawing illustrating a cross section of the cutting block and trim cushion, according to a particular embodiment;

FIG. 10 is an exploded perspective schematic of the lower portion of the concentric abrasive disc punch, according to a particular embodiment;

FIG. 11 is schematic drawing illustrating a top view of the lower portion of the concentric abrasive disc punch, according to a particular embodiment;

FIG. 12 is schematic drawing illustrating a side view of the lower portion of the concentric abrasive disc punch, according to a particular embodiment;

FIG. 13 is an exploded perspective schematic of the upper portion of the concentric abrasive disc punch, according to a particular embodiment;

FIG. 14 is schematic drawing illustrating a bottom view of the upper portion of the concentric abrasive disc punch, according to a particular embodiment; and

FIG. 15 is schematic drawing illustrating a side view of the upper portion of the concentric abrasive disc punch, according to a particular embodiment.

### DETAILED DESCRIPTION

Abrasive discs come in various sizes (e.g., five-inch, seven-inch, etc.). In some applications, an outer portion of the abrasive disc surface (e.g., nearer the edge diameter of the disc) may wear out faster than an inner portion of the abrasive disc surface (i.e., nearer the center of the disc), such as when the abrasive disc is applied at an angle to the work surface. Thus, even though an outer portion of the disc (e.g., outer two inches) may be unusable, an inner portion of the disc (e.g., inner five inches) may be usable for other applications.

To avoid waste, a disc with an unusable outer portion but a usable inner portion may be trimmed to a smaller size and reused, extending the usable life of the original sanding disc. For example, an unusable seven-inch disc may be trimmed to a usable five-inch disc. Although particular dimensions are used herein as an example, particular embodiments may apply to any disc sizes.

Trimming abrasive discs with scissors, shears, snips, a knife, etc., can be time consuming, inaccurate, and the abrasive surface quickly dulls the cutting edge of such instruments. Using a punch and die may improve speed of the cut and accuracy of the resulting shape (e.g., circle), but aligning the center of the abrasive disc with the punch and die is difficult and can be time consuming. Furthermore, the abrasive disc tends to curl when pushed into the die, which adversely impacts the accuracy of the cut.

Particular embodiments obviate the problems above and include a concentric abrasive disc punch. In general, the concentric abrasive disc punch includes a die arrangement with a cutting block and a punch. The cutting block includes a trim cushion. An abrasive disc is loaded onto the punch and in particular embodiments is automatically centered mechanically and/or magnetically on the punch. The punch is located accurately coaxially with the trim cushion and cutting block.

The punch is actuated by an industrial press, such as a hydraulic ironworker. The ram of the press compresses the gas or mechanical springs of the die set stripper. The punch first compresses the abrasive disc against the trim cushion, which flattens the disc. The punch continues to press the abrasive disc against the cutting block (the trim cushion is depressed within the cutting block). The cutting block has sharpened edges that shear the edges of the abrasive disc. An advantage is that the die set may be kept as a single unit and may be used in a press where the accuracy of the press' ram (which is usually not suited to precise tolerances) does not impact the accuracy of the punch.

In some embodiments, the cutting block edges are designed to progressively cut the edge from the backing material side to distribute the cutting action over the compression stroke and maintain alignment. Cutting from the backing material side of the abrasive disc prolongs the life of the cutting edge between sharpening. The design of the cutting edge also facilitates easy sharpening.

Particular embodiments use high and low tolerance parts to provide alignment and motion control along with adjustability. Stripper springs and/or cylinders provide the opening force, allowing the die set to be quickly installed and removed. Particular embodiments compensate for loose tolerances and limited space of the press.

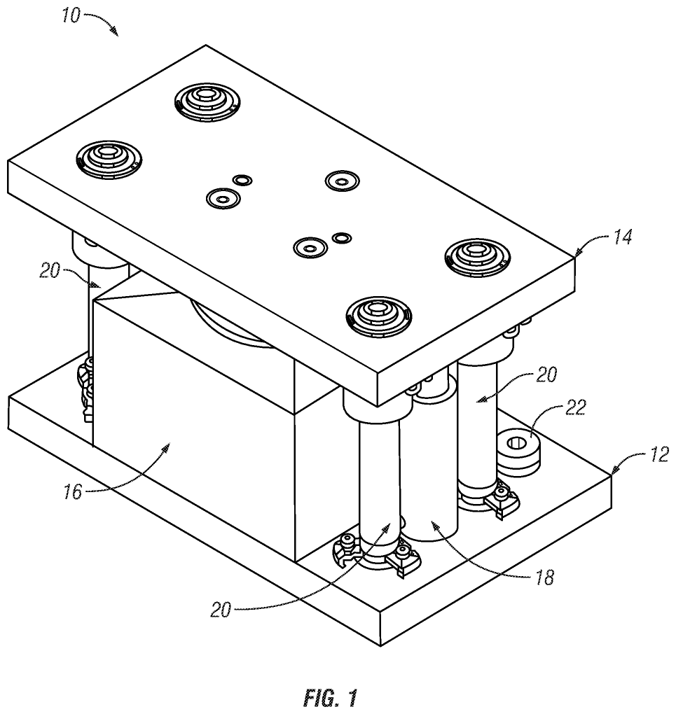

Particular embodiments and their advantages are best understood by reference to FIGS. 1 through 15, wherein like reference numbers indicate like features. Some figures may include dimensions or other specifications. The illustrated dimensions or specifications are examples, and other embodiments may include different dimensions or specifications.

FIG. 1 is a schematic perspective drawing illustrating a concentric abrasive disc punch, according to a particular embodiment. Concentric abrasive disc punch 10 comprises bottom plate 12 and top plate 14 to which the other components are attached. Bottom plate 12 is coupled to top plate 14 via springs 18 and guide pins 20. Cutting block 16 is coupled to bottom plate 12.

Guide pins 20, also referred to as guide posts or guide pillars, align bottom plate 12 and top plate 14. Springs 18 may comprise gas pistons, coil springs, or any other suitable spring.

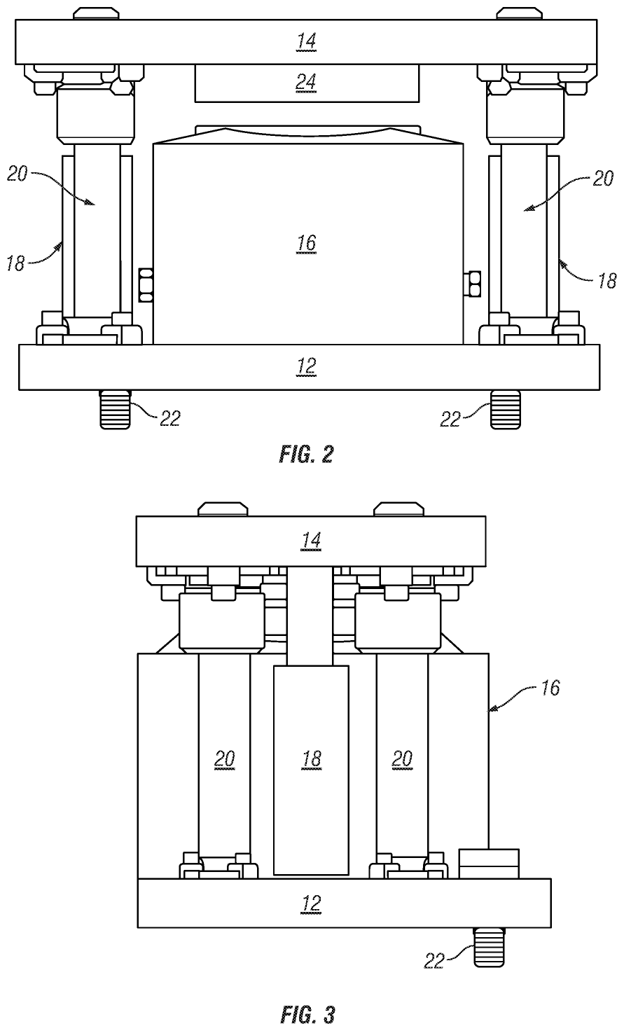

FIG. 2 is a schematic drawings illustrating a side view of a concentric abrasive disc punch, according to a particular embodiment. The side view illustrates bottom plate 12, top plate 14, cutting block 16, springs 18, and guide pins 20 illustrated in FIG. 1, as well as punch 24 coupled to top plate 14.

In operation, concentric abrasive disc punch 10 may be placed on the table of an industrial press, such as a hydraulic ironworker. Bottom plate 12 rests on the press' work table. The press' ram contacts top plate 14. Activation of the press compresses springs 18 as top plate 14 and punch 24 travel towards bottom plate 12 and cutting block 16. Guide pins 20 align punch 24 with the die opening in cutting block 16. Upon deactivation of the press, springs 18 lift top plate 14 and punch 24 away from bottom plate 12 and cutting block 16.

FIG. 3 is a schematic drawings illustrating an end view of a concentric abrasive disc punch, according to a particular embodiment. The end view illustrates bottom plate 12, top plate 14, cutting block 16, springs 18, and guide pins 20 illustrated in FIG. 1.

In particular embodiments, bottom plate 12 includes openings for couplers 22. Coupler 22 includes a bolt, screw, or other fastener for coupling concentric abrasive disc punch 10 to the press's work table. For example, steel shoulder screws may be used to fasten concentric abrasive disc punch 10 to the press' work table. In some embodiments, the underside of bottom plate 12 may include dowels or pins for locating concentric abrasive disc punch 10 on the work table.

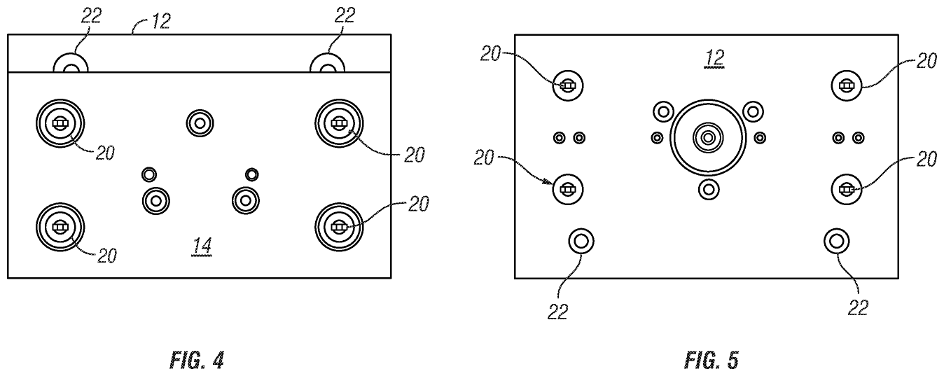

FIG. 4 is a schematic drawings illustrating an overhead view of a concentric abrasive disc punch, according to a particular embodiment. The overhead view illustrates the tops of guide pins 20 where they pass through top plate 14.

In particular embodiments, bottom plate 12 may be wider than top plate 14, as illustrated, which facilitates access to couplers 22 from above. An advantage is that concentric abrasive disc punch 10 may be easily and quickly coupled to the press' work table.

FIG. 5 is a schematic drawings illustrating an underneath view of a concentric abrasive disc punch, according to a particular embodiment. The underneath view illustrates the bottom of guide pins 20 where they are coupled to bottom plate 12.

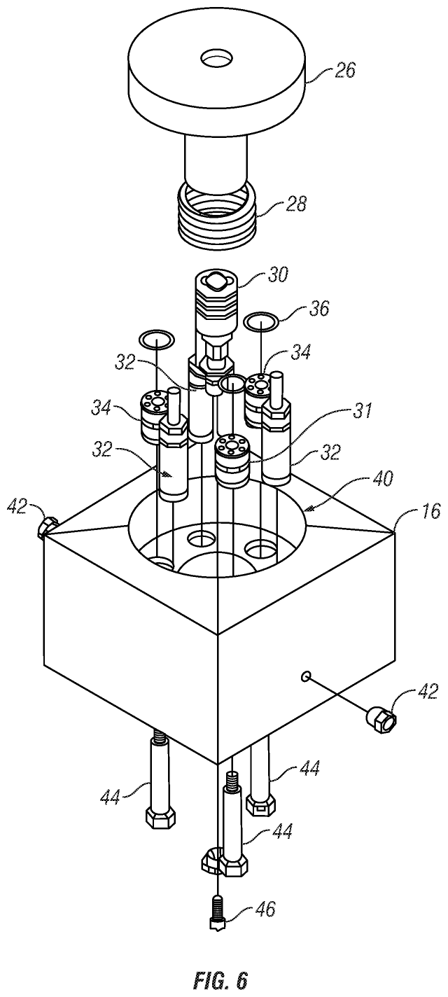

FIG. 6 is an exploded perspective schematic of the cutting block and trim cushion, according to a particular embodiment. Cutting block 16 includes cutting edge 40 for trimming abrasive discs and trim cushion 26 located within the circumference of cutting edge 40, as well as various springs and guides for trim cushion 26.

As illustrated, cutting edge 40 forms a circular diameter for cutting round abrasive discs. For example, cutting edge 40 may comprise a five inch diameter for cutting abrasive discs larger than five inches (e.g., seven inches) into five inch abrasive discs. In other embodiments, cutting edge 40 may comprise any suitable diameter or any suitable shape for cutting abrasive discs.

Cutting edge 40 is formed by the vertical walls of the void within the circumference of cutting edge 40 and the sloping top portion of cutting block 16 that slopes downward from cutting edge 40 towards the sides of cutting block 16. As punch 24 pushes the abrasive disc onto cutting edge 40 the sloping portions progressively shear the edges of the abrasive disc.

The progressive cut distributes the cutting action over the compression stroke and maintains proper alignment of the abrasive disc during the compression stroke. The sloping top portion of cutting block 16 facilitates easy sharpening.

Trim cushion 26 is located concentrically within the cutting opening of cutting block 16 (e.g., the void within cutting edge 40). Trim cushion 26 comprises a flat horizontal face that supports the abrasive disc prior to and during the cutting process to prevent curling of the abrasive disc. Trim cushion 26 is spring activated and travels vertically during portions of the compression stroke of concentric abrasive disc punch 10.

Trim cushion 26 is coupled to linear guide 30 which restricts lateral motion during the vertical compression stroke of trim cushion 26. Linear guide 30 is coupled to cutting block 16 via coupler 46. Coupler 46 may comprise a socket head cap screw or any other suitable fastener.

Particular embodiments may include spring 28 positioned concentrically around linear guide 30. Spring 38 may provide damping and rebound to trim cushion 26 during the compression stroke.

Particular embodiments may provide damping and rebound to trim cushion 26 via gas cylinders 32. Gas cylinders 32 may be coupled to the underneath side of trim cushion 26 and a supporting ledge within the cutting opening of cutting block 16. Guide pins 38 (see FIG. 9) may also restrict lateral motion during the vertical compression stroke of trim cushion 26. Guide pins may be coupled to the underneath side of trim cushion 26 and travel within bearings 34 coupled to cutting block 16 via retaining rings 36.

In some embodiments, cutting block 16 includes one or more breathers 42. Breather 42 permits air flow into and out of the voids between cutting block 16 and trim cushion 26 during the compression stroke of concentric abrasive disc punch 10. Although the illustrated example includes a particular number and placement of breathers 42, other embodiments may include any suitable number and placement of breathers 42.

Some embodiments may include a regulated air source (not illustrated). The regulated air source may be connected to breathers 42 or may have its own connection or connections to the voids between cutting block 16 and trim cushion 26. The regulated air source provides a positive air pressure in the voids between cutting block 16 and trim cushion 26 to reduce the amount of cutting debris (e.g., abrasive granules, backing material, etc.) that may fall between trim cushion 26 and cutting edge 40.

Cutting block 16 may be coupled to bottom plate 12 with couplers 44. Couplers 44 may comprise a steel shoulder screw or any other suitable fastener.

Although a particular number and configuration of guide pins, springs, and couplers/fasteners are illustrated as examples, other embodiments may include any suitable number and/or configuration of guide pins, springs, and couplers/fasteners.

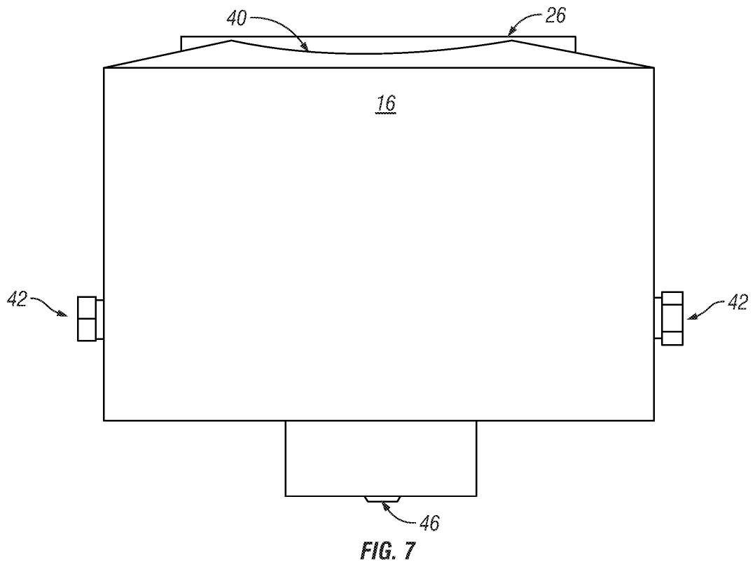

FIG. 7 is a schematic drawing illustrating a side view of the cutting block and trim cushion, according to a particular embodiment. As illustrated, when concentric abrasive disc punch 10 is in the open position, the flat horizontal face of trim cushion 26 is positioned just above the opening of cutting edge 40. During the compression stroke of concentric abrasive disc punch 10, the abrasive disc first contacts trim cushion 26, which flattens the abrasive disc prior to cutting. The abrasive disc is then supported by trim cushion 26 for the remainder of the cutting stroke.

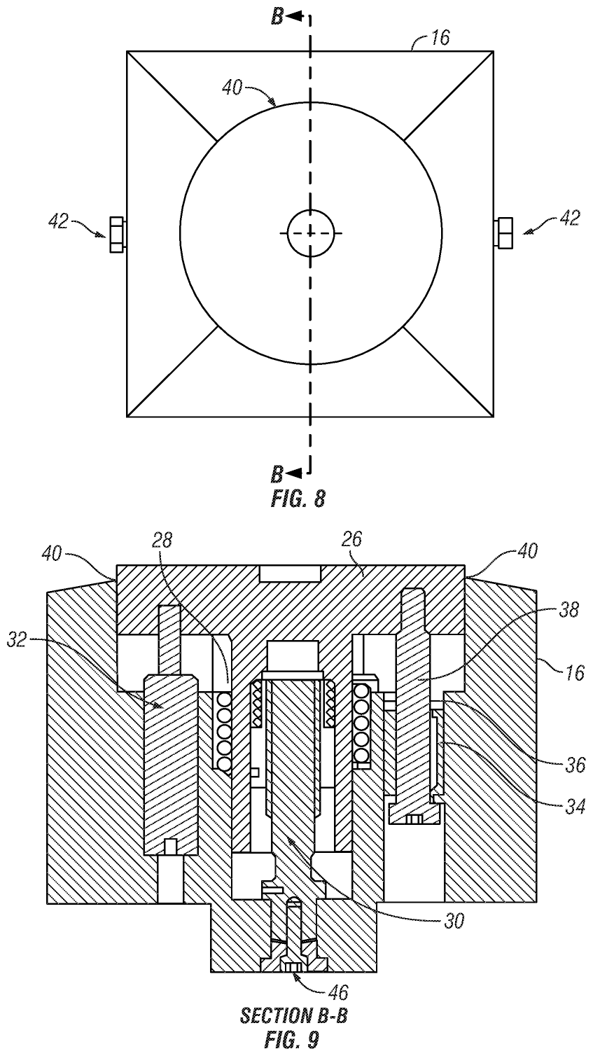

FIG. 8 is a schematic drawing illustrating a top view of the cutting block and trim cushion, according to a particular embodiment. A cross section of cutting block 16 along the line labeled B-B is illustrated in FIG. 9.

FIG. 9 is schematic drawings illustrating a cross section of the cutting block and trim cushion, according to a particular embodiment. As described with respect to FIG. 6, trim cushion 26 travels up and down in within the cutting opening of cutting block 16. Linear guide 30 and guide pins 38 provide lateral stability. Guide pins 38 travel up and down within bearings 34 during the cutting stroke. Gas cylinders 32 and spring 28 provide damping and rebound to trim cushion 26.

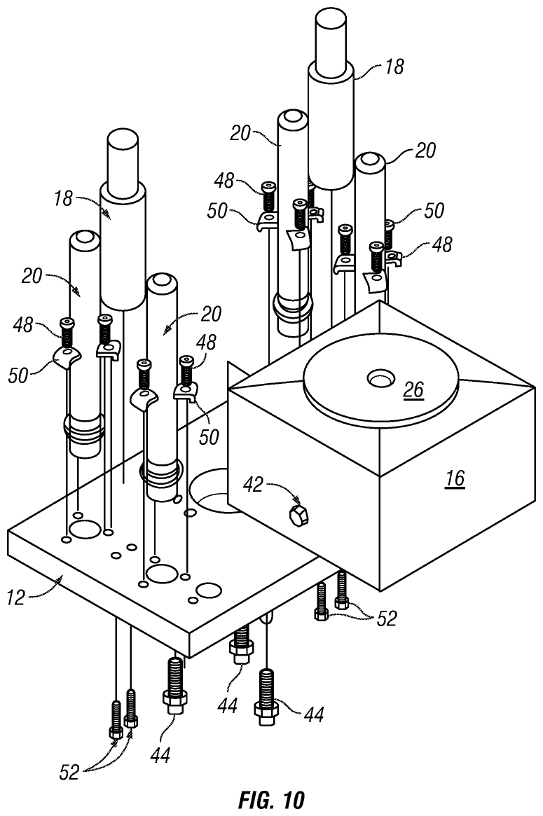

FIG. 10 is an exploded perspective schematic of the lower portion of the concentric abrasive disc punch. The exploded schematic illustrates how the various components of concentric abrasive disc punch 10 are coupled to bottom plate 12.

For example, cutting block 16 may be coupled to bottom plate 12 via couplers 44. In some embodiments, the pins of guide pins 20 may be coupled to bottom plate 12 via screws 48 and clamps 50. The bottom of guide pins 20 may be recessed into bottom plate 12. Springs 18 may be coupled to bottom plate 12 via screws 52, or any other suitable fastener.

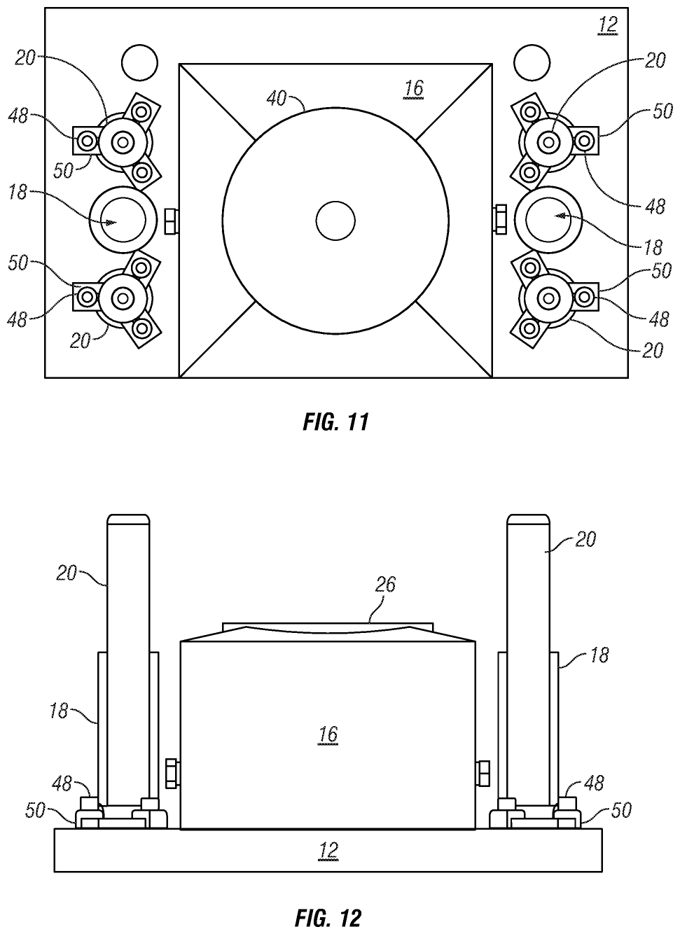

FIG. 11 is schematic drawing illustrating a top view of the lower portion of the concentric abrasive disc punch, according to a particular embodiment. With top plate 14 removed for ease of illustration, FIG. 11 illustrates bottom plate 12 with cutting block 16, guide pins 20 coupled to bottom plate 12 via screws 48 and clamps 50, and springs 18.

FIG. 12 is schematic drawing illustrating a side view of the lower portion of the concentric abrasive disc punch, according to a particular embodiment. The side view illustrates bottom plate 12 with cutting block 16 and trim cushion 26, guide pins 20 coupled to bottom plate 12 via screws 48 and clamps 50, and springs 18.

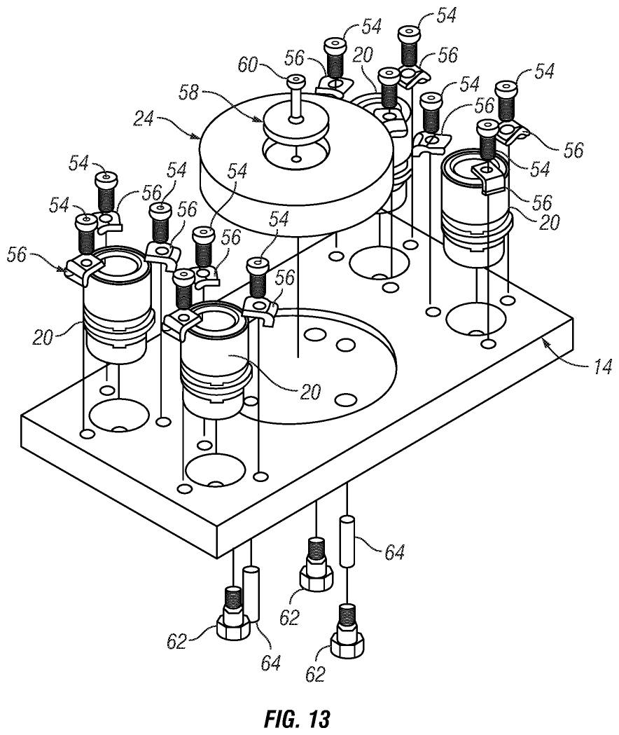

FIG. 13 is an exploded perspective schematic of the upper portion of the concentric abrasive disc punch, according to a particular embodiment. The exploded schematic illustrates how the various components of concentric abrasive disc punch 10 are coupled to top plate 14.

For example, punch 24 may be coupled to top plate 14 via screws 62 and/or dowel pins 64. In some embodiments, the bushing of guide pins 20 may be coupled to top plate 14 via screws 54 and clamps 56. The bushings of guide pins 20 may be recessed into top plate 14.

In some embodiments, punch 24 includes magnet 58. Magnet 58 may be coupled to punch 24 via screw 60, or any other suitable fastener. Magnet 58 may comprise a rubber encased neodymium magnet, or any other suitable magnet. Magnet 58 is positioned at the center of punch 24 and may be used to quickly align the abrasive disc with punch 24 and cutting edge 40. For example, many abrasive discs include a metal fastener for attaching the abrasive disc to a work tool, such as a grinder or sanding machine. As the operator inserts the abrasive disc into concentric abrasive disc punch 10, the metal faster is attracted to magnet 58, which facilitates fast yet accurate placement of the abrasive disc.

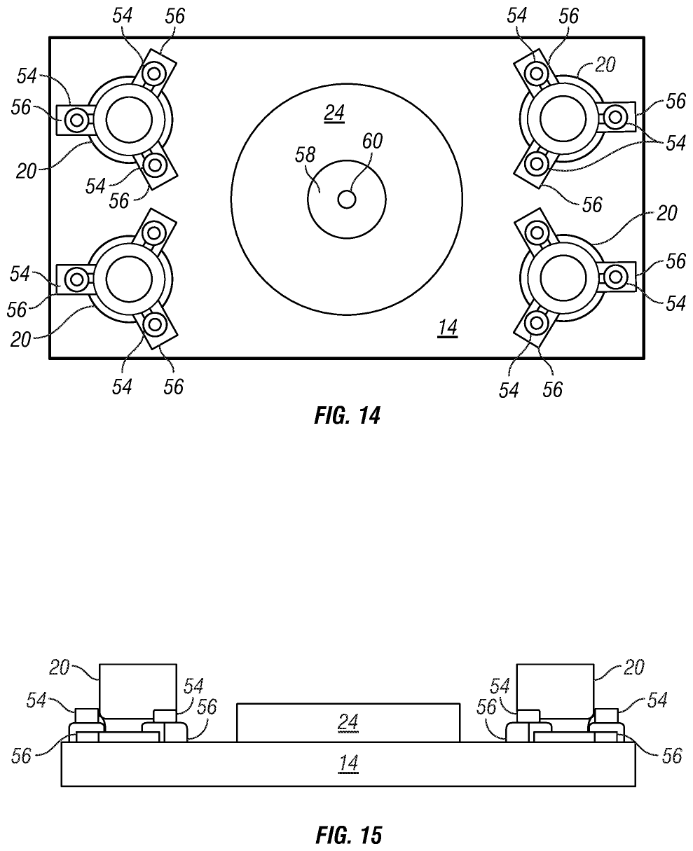

FIG. 14 is schematic drawing illustrating a bottom view of the upper portion of the concentric abrasive disc punch, according to a particular embodiment. With bottom plate 12 removed for ease of illustration and looking up at top plate 14, FIG. 14 illustrates top plate 14 with punch 24, magnet 58, and the bushings of guide pins 20 coupled to top plate 14 via screws 54 and clamps 56.

FIG. 15 is schematic drawing illustrating a side view of the upper portion of the concentric abrasive disc punch, according to a particular embodiment. The side view illustrates top plate 14 with punch 24 and the bushings of guide pins 20 coupled to top plate 14 via screws 54 and clamps 56.

Although the examples above illustrate a particular number and configuration of guide pins, springs, and fasteners, other embodiments may include any suitable number and/or configuration of guide pins, springs, and fasteners.

In operation, an operator places concentric abrasive disc punch 10 on the work table of an industrial press. In some embodiments, the operator may secure concentric abrasive disc punch 10 to the work table using coupler 22 (e.g., screws, bolts, dowels, or any combination of fasteners).

Concentric abrasive disc punch 10 is in the open position which provides vertical space between punch 24 and cutting block 16. The operator inserts an abrasive disc into the open space between punch 24 and cutting block 16. As the abrasive disc nears punch 24, magnet 58 secures and aligns the abrasive disc to punch 24. The abrasive disc is loaded with its backing material facing cutting block 16.

After the abrasive disc is loaded into concentric abrasive disc punch 10, the operator activates the industrial press. The ram of the industrial press contacts top plate 14 and exerts a downward force compressing concentric abrasive disc punch 10. During the compression stroke, the abrasive disc contacts first contacts trim cushion 26, which flattens the abrasive disc prior to cutting. As the compression stroke continues, the abrasive disc continues to be supported by trim cushion 26 and the abrasive disc contacts cutting edge 40.

As punch 24 pushes the abrasive disc onto cutting edge 40 the sloping edges of cutting block 16 progressively shear the edges of the abrasive disc. The progressive cut distributes the cutting action over the compression stroke and maintains proper alignment of the abrasive disc during the compression stroke.

After the abrasive disc is cut, the operator deactivates the press. The ram retracts removing downward force on concentric abrasive disc punch 10. Springs 18 return concentric abrasive disc punch 10 to the open position where the operator is able to remove the newly cut abrasive disc and the waste material from the original abrasive disc. The operator may repeat the process to cut additional abrasive discs as needed.

Although particular embodiments and their advantages have been described in detail, it should be understood that various changes, substitutions and alternations can be made herein without departing from the spirit and scope of the embodiments.

1. An abrasive disc punch comprising:
a bottom plate;
a top plate parallel to the bottom plate and coupled to the bottom plate via two or more guide pins;
two or more springs coupled between the bottom plate and the top plate;
a punch coupled to the top plate;
a cutting block coupled to the bottom plate, the cutting block comprising a top portion with a cutting edge, the cutting edge aligned coaxially with the punch;
a trim cushion coupled to the cutting block via at least one spring, the trim cushion positioned within the cutting edge of the cutting block, the trim cushion comprising a flat horizontal top portion for supporting an abrasive disc; and
wherein in an open position the two or more springs separate the top plate and punch from the bottom plate and the cutting block, and the flat horizontal top portion of the trim cushion is positioned above the cutting edge of the cutting block.

2. The abrasive disc punch of claim 1, wherein a top portion of the cutting block slopes downward and away from the cutting edge towards the sides of the cutting block.

3. The abrasive disc punch of claim 1, wherein the punch includes a magnet centered coaxially on the punch for aligning an abrasive disc.

4. The abrasive disc punch of claim 1, wherein the cutting block further comprises one more breathers that permit air flow into and out of voids between the cutting block and the trim cushion during a compression stroke of the abrasive disc punch.

5. The abrasive disc punch of claim 4, further comprising a regulated air source coupled to the one or more breathers.

6. The abrasive disc punch of claim 1, wherein the cutting edge forms a five inch diameter circle.

7. The abrasive disc punch of claim 1, comprising two guide pins positioned along a first edge of the top plate and the bottom plate and two guide pins positioned along a second edge opposite the first edge of the top plate and the bottom plate.

8. The abrasive disc punch of claim 1, further comprising a liner guide coupled to the trim cushion and configured to restrict lateral movement of the trim cushion during a compression stroke of the abrasive disc punch.

9. The abrasive disc punch of claim 1, wherein the two or more springs comprise two or more gas pistons.

10. A method for trimming an abrasive disc, the method comprising:
positioning an abrasive disc punch on a work table of a press, wherein the abrasive disc punch comprises:
a bottom plate;
a top plate parallel to the bottom plate and coupled to the bottom plate via two or more guide pins;
two or more springs coupled between the bottom plate and the top plate;
a punch coupled to the top plate;
a cutting block coupled to the bottom plate, the cutting block comprising a top portion with a cutting edge, the cutting edge aligned coaxially with the punch;
a trim cushion coupled to the cutting block via at least one spring, the trim cushion positioned within the cutting edge of the cutting block, the trim cushion comprising a flat horizontal top portion for supporting an abrasive disc;
wherein in an open position the two or more springs separate the top plate and punch from the bottom plate and the cutting block, and the flat horizontal top portion of the trim cushion is positioned above the cutting edge of the cutting block;
inserting an abrasive disc into the abrasive disc punch;
activating the press to compress the abrasive disc punch causing the punch to shear the abrasive disc against the cutting edge;
deactivating the press to return the abrasive disc punch to the open position; and
removing the trimmed abrasive disc from the abrasive disc punch.

11. The method of claim 10, wherein a top portion of the cutting block slopes downward and away from the cutting edge towards the sides of the cutting block.

12. The method of claim 10, wherein the punch includes a magnet centered coaxially on the punch, and inserting the abrasive disc into the abrasive disc punch comprises coupling a metal fastener of the abrasive disc to the magnet.

13. The method of claim 10, wherein the cutting block further comprises one more breathers that permit air flow into and out of voids between the cutting block and the trim cushion during a compression stroke of the abrasive disc punch.

14. The method of claim 13, the abrasive disc punch further comprising a regulated air source coupled to the one or more breathers.

15. The method of claim 10, wherein the cutting edge forms a five inch diameter circle.

16. The method of claim 10, wherein the abrasive disc punch comprises two guide pins positioned along a first edge of the top plate and the bottom plate and two guide pins positioned along a second edge opposite the first edge of the top plate and the bottom plate.

17. The method of claim 10, wherein the abrasive disc punch further comprises a liner guide coupled to the trim cushion and configured to restrict lateral movement of the trim cushion during a compression stroke of the abrasive disc punch.

18. The method of claim 10, wherein the two or more springs comprise two or more gas pistons.
